(19) United States
(12) Patent Application Publication
(10) Pub. No.: US 2011/0137719 A1
(43) Pub. Date: Jun. 9, 2011

(54) EVENT-CENTRIC COMPOSABLE QUEUE, AND COMPOSITE EVENT DETECTION METHOD AND APPLICATIONS USING THE SAME

(75) Inventors: Junehwa SONG, Daejeon (KR); Sangjeong LEE, Daejeon (KR); Youngki LEE, Daejeon (KR); Byoungjip KIM, Daejeon (KR); Yun Seok RHEE, Gyeonggi-do (KR)

(73) Assignee: KOREA ADVANCED INSTITUTE OF SCIENCE AND TECHNOLOGY, Daejeon (KR)

(21) Appl. No.: 12/758,110

(22) Filed: Apr. 12, 2010

(30) Foreign Application Priority Data
Dec. 8, 2009 (KR) 10-2009-0121334

(51) Int. Cl. G06F 17/30; G06Q 30/00; G06Q 40/00; G06Q 10/00; G06F 17/00

(52) U.S. Cl. 705/14.25; 705/14.49; 705/35; 705/1.1; 705/333; 235/375; 707/802; 707/E17.044

(57) ABSTRACT

Disclosed herein are an Event-centric Composable Queue (ECQ), and a composite event detection method and applications using the same. The ECQ includes a Composition Link Table (CLT) having basic information about the composition of a network of ECQs, a Shared Instance Queue (SIQ) for storing preceding event objects which are shared by a plurality of detection sentences and which are required for composite event detection, and a Partial Composition Block (PCB) for storing the intermediate results of the calculation of the extent to which each stored event object satisfies a specific composite event detection sentence.

### CROSS REFERENCE TO RELATED APPLICATION

This application claims the benefit of Korean Patent Application No. 10-2009-0121334, filed on Dec. 8, 2009, entitled “Event-centric Composable Queue and Composite Event Detection Method and Applications using ECQ,” which is hereby incorporated by reference in its entirety into this application.

### BACKGROUND OF THE INVENTION

1. Field of the Invention

The present invention relates to an Event-centric Composable Queue (ECQ) and a composite event detection method and applications using the ECQ.

2. Description of the Related Art

Composite event detection started from a trigger detection system in the active database field, and is a technology capable of detecting the occurrence of an event in the case where, when an event occurs, the event acts as a trigger and causes another operation or action.

Methods for performing such composite event detection includes a method based on finite state automata (see [HiPAC] U. Dayal et al. The hipac project: Combining active databases and timing constraints. SIGMOD RECORD, 17 1:51-700, March 1988; [Ode] N. Gehani and H. V. Jagadish. Ode as an active database: Constraints and triggers. In VLDB, September 1991), a method based on a Petri Net (see [SAMOS] S. Gatziu and K. Dittrich. Events in an active object-oriented database. In Workshop on Rules in Database Systems, 1994), and a method based on an event tree (see [Sentinel] S. Chakravarthy, V. Krishnaprasad, E. Anwar, and S. Kim Composite events for active databases: Semantics, contexts and detection in LVDB, 1994). Recently, a composite event detection system for a large amount of event input has been researched based on Finite State Automata (FSA) (see [SASE08] J. Agrawal, Y. Diao, D. Gyllestrom, and N. Immerman, Efficient pattern matching over event streams. In SIGMOD, 2008; [SASE06] E. Wu, Y. Diao, and S. Rizvi. High-performance complex event processing over streams. In SIGMOD, 2006; [Cayuga] A. Demers, J. Gehrke, B. Panda, M. Riedewald, V. Sharma, and W. White. Cayuga: A general purpose event monitoring system. In CIDR, January 2007).

According to this method, input event objects are redundantly transmitted to each detection sentence, and processing actions redundantly appear in each detection sentence. Accordingly, as the number of detection sentences increases, the processing cost increases in proportion thereto, so that there is the problem of inefficiently processing a large number of detection sentences when the detection sentences are registered.

### SUMMARY OF THE INVENTION

Accordingly, the present invention has been made keeping in mind the above problems occurring in the prior art, and an object of the present invention is to provide a technology which is configured to create only one ECQ for each event type and to construct a network of ECQs in accordance with registered composite event detection sentences, thereby providing optimum efficiency in terms of computation cost and storage cost without performing hardware addition, such as the use of nonvolatile memory.

In order to accomplish the above object, the present invention provides an ECQ, including a Composition Link Table (CLT) having basic information about the composition of a network of ECQs; a Shared Instance Queue (SIQ) for storing preceding event objects which are shared by a plurality of detection sentences and which are required for composite event detection; and a Partial Composition Block (PCB) for storing the intermediate results of the calculation of the extent to which each stored event object satisfies a specific composite event detection sentence.

The CLT may have a row for a composite event detection sentence Qⱼ in which a corresponding ECQ (ECQᵢ) participates, which is denoted by CLink(ECQᵢ, Qⱼ).

The CLink(ECQᵢ, Qⱼ) may includes the identifier id_{Q} of a detection sentence, the type of corresponding composite event, Furthermore, a time constraint t_{cond} for completion of a corresponding composite event, a set of pointers ptr_{ECQ} for remaining ECQs, a location or feature flag which a corresponding ECQ has in a corresponding composite event type, and the conditions attr_condition of attributes expressed in the composite event detection sentence, as columns thereof.

The type may have any one value of SEQ for a sequence type, ALL for a conjunction type and ANY for a disjunction type.

The flag may have any one value of INIT for a foremost part of a sequence, FINE for a rearmost part of a sequence, NEG for a negation type, KC for a Kleene closure type and +(one or more occurrences), (zero or more occurrence), and c (arbitrary natural number; c or more occurrences) which is numerical information of a Kleene closure.

The SIQ may include a queue for storing event objects in order of input and a hash table for efficiently searching for stored event objects.

The PCB may be created for each stored event object, and have a row denoted by PComp(eₖ, Qⱼ) representative of information about how an event object eₖ stored for each composite event detection sentence partially satisfied by the event object satisfies a detection sentence Qⱼ.

The PCB may include the identifier id_{Q} of a partially satisfied detection sentence, the time tₛₜₐᵣₜ when currently stored partial combination started, and a set of pointers ptr_{instance} of preceding event objects which have enabled partial combination resulting from a currently stored event object eₖ.

Additionally, the present invention provides a composite event detection method using an ECQ, including implementing and registering a target composite event detection sentence using a network of ECQs; deleting an unnecessary composite event detection sentence from the network; and, when an event object is input, detecting a composite event from the network of ECQs.

The detecting a composite event includes checking whether the input event object extends or newly creates partial combination of a corresponding detection sentence for all detection sentences in which a corresponding event participates; and, if the input event object extends or newly creates partial combination of one or more detection sentences, storing the input event object inside the ECQ once, and if the input event object does not extend or newly create partial combination, discarding the input event object.

Additionally, the present invention provides an advertising method using an ECQ, including implementing and registering a composite event detection sentence, used to compositely detect use of a specific card at a specific location and in a specific period in order to monitor a series of card uses in real time, using a network of ECQs; deleting an event detection sentence related to use of the specific card at an unnecessary location or in an unnecessary period from the network; and transmitting a preset advertisement to a relevant mobile device in response to use of the card detected using the composite event detection sentence.

Additionally, the present invention provides an advertising method using an ECQ, including implementing and registering a composite event detection sentence, used to compositely detect a purchase of a specific product in order to detect a composite shopping activity in real time, using a network of ECQs; deleting an event detection sentence related to an unnecessary purchase from the network; and transmitting a preset advertisement or discount coupon in response to a purchase detected using the composite event detection sentence.

Additionally, the present invention provides a finance management method using an ECQ, including implementing and registering a composite event detection sentence, used to compositely detect a specific economic index in order to understand an economic situation in real time, using a network of ECQs; deleting an event detection sentence related to an unnecessary index from the network; and taking preset measures in response to the economic index detected using the composite event detection sentence.

Additionally, the present invention provides a large-sized store product management method using an ECQ, including implementing and registering a composite event detection sentence, used to compositely detect movement of one of various products in a large-sized store, using a network of ECQs; deleting an event detection sentence related to an unnecessary product from the network; and taking preset measures in response to movement of a product detected using the composite event detection sentence.

The implementing and registering a composite event detection sentence may be implementing and registering a composite event detection sentence used to compositely detect a case where a product is moved from a store without passing through a counter, using a network of ECQs; and the taking preset measures may be providing notification of a theft of the product.

The implementing and registering a composite event detection sentence may be implementing and registering a composite event detection sentence used to compositely detect a case where a product is moved from a store through a counter and an expiration date of the product has passed, using a network of ECQs; and the taking preset measures may be immediately notifying a customer of the passing of the expiration date.

Additionally, the present invention provides a delivery management method using an ECQ, including implementing and registering a composite event detection sentence, used to compositely detect arrival of a specific product at a delivery destination and passing of the product through an intermediate location, using a network of ECQs; deleting an event detection sentence related to an unnecessary product from the network; and monitoring movement of a product other than movement of the first product detected using the composite event detection sentence.

Additionally, the present invention provides a facilities monitoring method using an ECQ, including implementing and registering a composite event detection sentence, used to compositely detect use of each of various facilities, using a network of ECQs; deleting an event detection sentence related to an unnecessary facility from the network; and analyzing a pattern of the use of facilities detected by the composite event detection sentence.

Additionally, the present invention provides a public transportation management method using an ECQ, including implementing and registering a composite event detection sentence, used to compositely detect transfer to another transportation means using a traffic card, using a network of ECQs; deleting an event detection sentence related to unnecessary transfer information from the network; and managing public transportation based on transfer information detected using the composite event detection sentence.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows the structure of an ECQ according to the present invention;

FIG. 2 shows the representation of a sequence for representing successive events, using ECQs;

FIG. 3 shows the representation of a disjunction in which events occur in the relationship of logical sum “OR,” using ECQs;

FIG. 4 shows the representation of a conjunction in which events occur at the same time, that is, in the relationship of logical product “AND”;

FIG. 5 shows the representation of a negation in which only events A and C occur but an event B does not occur, using ECQs;

FIG. 6 shows the representation of a Kleene closure in which an event B (b₄ or b₂) occurs at least once after an event A and then an event C occurs, using ECQs;

FIG. 7 shows the representation and sharing of five composite event detection sentences in and by a group of ECQs (a network of ECQs, N-ECQ);

FIG. 8 shows an algorithm for the step of newly registering a composite event detection sentence in a network of ECQs (N-ECQ) according to the present invention;

FIG. 9 shows an algorithm for a process of detecting a composite event for event object inputs according to the present invention;

FIG. 10 shows an algorithm for the conjunction of event objects according to the present invention;

FIG. 11 shows a probe_join operation which is used for composite event detection according to the present invention;

FIG. 12 shows the comparison of performance between the existing FSA-based composite event detection system and the present invention with respect to a Kleene closure;

FIG. 13 shows the comparison of performance between the present invention and a control invention with respect to a sequence;

FIG. 14 shows the comparison of performance between the present invention and the control invention with respect to a conjunction;

FIG. 15 shows the comparison of performance between the present invention and the control invention with respect to a disjunction; and

FIG. 16 shows the comparison of performance between the present invention and the control invention with respect to a negation.

### DESCRIPTION OF THE PREFERRED EMBODIMENTS

Reference now should be made to the drawings, in which the same reference numerals are used throughout the different drawings to designate the same or similar components.

The present invention proposes an ECQ to handle the detection of a composite event.

An ECQ is created for each event type, and processes, manages and stores all event objects corresponding to the relevant event type. An ECQ is divided into three parts.

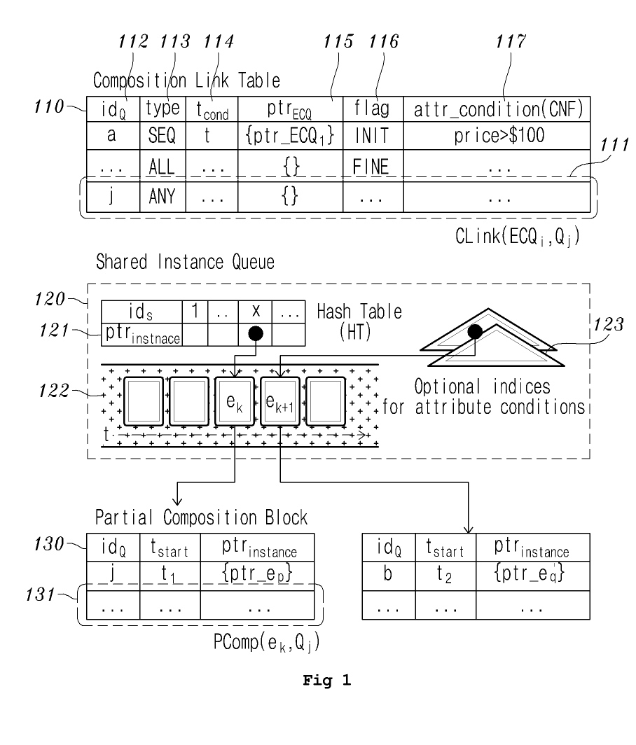

FIG. 1 is a diagram showing the structure of an ECQ according to the present invention in detail.

A Composition Link Table (CLT) 110 contains basic information about the composition of a network of ECQs.

When a composite event detection sentence is registered, ECQs corresponding to event types described in the detection sentence are combined with each other according to the event combination method and type.

A CLT has one row for each composite event detection sentence Qⱼ in which a relevant ECQ ECQ1 participates, and the row is referred to CLink(ECQᵢ, Qⱼ) 111. CLink(ECQᵢ, Qⱼ) 111 indicates that ECQs are combined with each other in the detection sentence Qⱼ.

The columns of a CLT represent information in each CLink. id_{Q} 112 represents the identifier of a detection sentence, and type 113 represents the type of corresponding composite event.

Furthermore, t_{cond} 114 represents the time constraint for the completion of a corresponding composite event, ptr_{ECQ} 115 represents a set of pointers for the other ECQs, and flag 116 represents a location or feature characteristic which a corresponding ECQ has in a corresponding composite event type.

Meanwhile, attr_condition 117 has the conditions of attributes expressed in the other composite event detection sentences in conjunctive normal form.

The values which the type can have include SEQ for a sequence type, ALL for a conjunction type, and ANY for a disjunction type.

Furthermore, the values which the flag can have include INIT for the foremost part of a sequence, FINE for the rearmost of a sequence, NEG for a negation type, and KC for a Kleene closure type. The flag may further have the numerical information of the Kleene closure (+/*/arbitrary natural number).

Another part of the ECQ is a Shared Instance Queue (SIQ) 120. An SIQ 120 efficiently stores preceding event objects required for the detection of a composite event so that they are shared by a plurality of detection sentences. An SIQ 120 has indices, including a queue 122 for storing event objects in order of input and a hash table 121 for efficiently searching for stored event objects.

The hash table 121 has pointers ptr_{instance} which point to corresponding objects from the identifiers id_{Q} of the action targets of event objects.

Additionally, an SIQ may have indices 123 for enabling the attribute conditions of auxiliary composite event detection sentences to be rapidly determined.

Yet another part of the ECQ is a Partial Composition Block (PCB) 130. The PCB 130 stores the intermediate results of the calculation of the extent to which each stored event object satisfies a specific composite event detection sentence.

A PCB is created for each stored event object, and has a row for each composite event detection sentence which has been partially satisfied by the object. The row is referred to as PComp(eₖ, Qⱼ) 131.

PComp(eₖ, Qⱼ) 131 represents information about how an event object eₖ has satisfied a detection sentence Qⱼ. The columns of the PCB represent important information in each PComp.

id_{Q} represents the identifier of a partially satisfied detection sentence, tₛₜₐᵣₜ represents the time when currently stored partial combination started, ptr_{instance} represents a set of pointers of preceding event objects which have enabled partial combination resulting form a currently stored event object eₖ.

tₛₜₐᵣₜ is used when the time constraint of a composite event detection sentence is examined, and the pointers ptr_{instance} are used to find event objects while recursively following the pointers when a composite event is finally completed later and information about event objects which have enabled the completion is transmitted.

For each composite event type, how a composite event detection sentence is registered in a network of ECQs and, for a series of event object inputs, how partial combination is calculated and how the completion of a composite event is detected will be described with reference to the accompanying drawings.

In the drawings, the upper gray part 201 of an ECQ schematically represents a CLT, the intermediate box 202 schematically represents an SIQ, and the lower box 203 schematically represents a PCB. This structure is applied to a non-shown ECQ in the same manner.

It is assumed that a series of event object inputs used for description is configured such that the same object generates and transmits an event object a₁ corresponding to an event type A at time 1, an event object b₂ corresponding to an event type B at time 2, an event object c₃ corresponding to an event type C at time 3, an event object b₄ corresponding to an event type B at time 4, and an event object c₅ corresponding to an event type C at time 5.

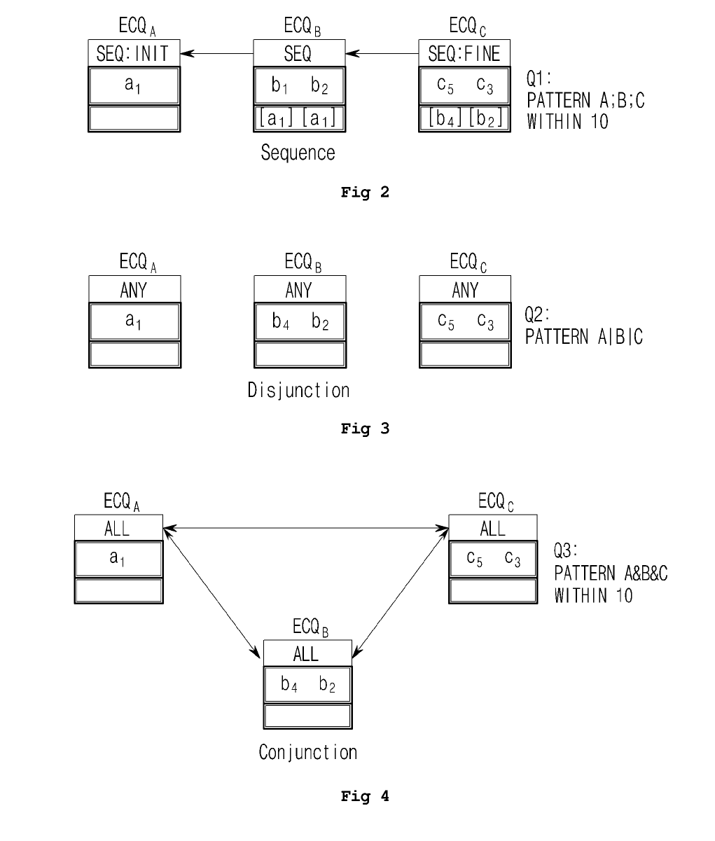

FIGS. 2 to 6 are drawings showing the representation of operations required for the detection of a composite event using ECQs. Each of the drawings schematically shows the case where an exemplary detection sentence is represented using a network of ECQs. The upper CLT part 201 represents the type and the flag. The intermediate SIQ part 202 represents the storage of event objects which produce partial combination in time sequence. Finally, the lower PCB part 203 represents preceding event objects which enable each stored event object to produce partial combination.

FIG. 2 shows the representation of a sequence for representing successive events, using ECQs.

FIG. 3 shows the representation of a disjunction in which events occur in the relationship of logical sum “OR,” using ECQs.

FIG. 4 shows the representation of a conjunction in which events occur at the same time, that is, in the relationship of logical product “AND.”

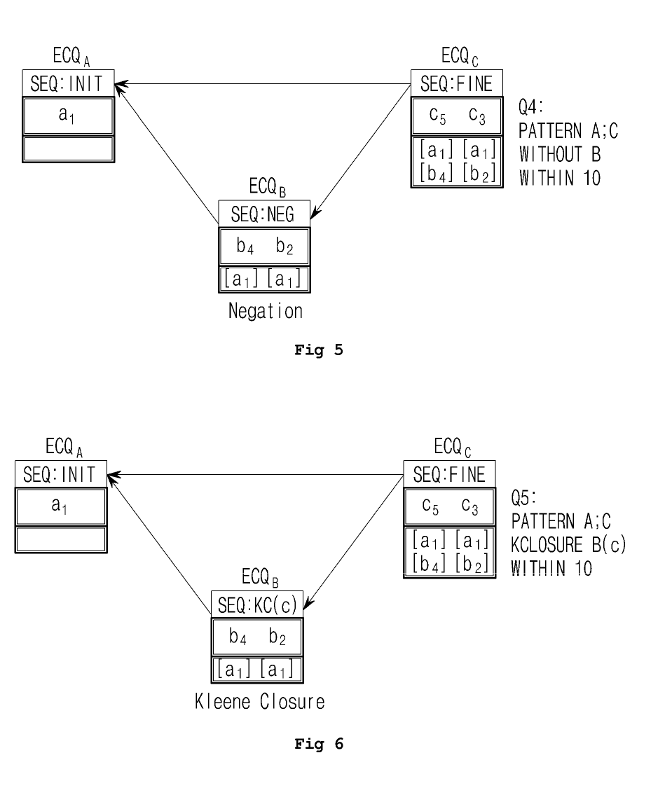

FIG. 5 shows the representation of a negation in which only events A and C occur but an event B does not occur, using ECQs.

A Kleene closure is an operation which detects the case where a specific event or expression occurs at least a specific number of times.

FIG. 6 shows the representation of a Kleene closure in which an event B (b₄ or b₂) occurs at least an arbitrary natural number c of times after an event A and then an event C occurs, using ECQs.

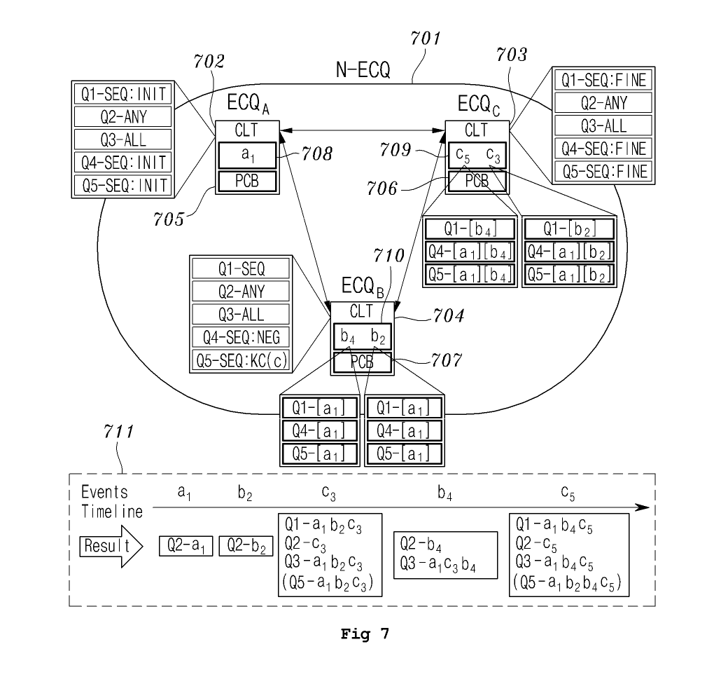

FIG. 7 shows the representation and sharing of five composite event detection sentences in and by a group of ECQs (a network of ECQs, N-ECQ) 701.

In FIG. 7, CLTs 702, 703 and 704 and PCB parts 705, 706 and 707 are created in accordance with corresponding detection sentences, and the event objects of SIQ parts 708, 709 and 710 are shared by the detection sentences and efficiently stored.

The reference numeral 711 of FIG. 7 represents the results of composite event detection for a series of predetermined event object inputs.

The composite event detection according to the present invention starts with a composite event detection sentence registration step of newly registering a composite event detection sentence in a network of ECQs N-ECQ.

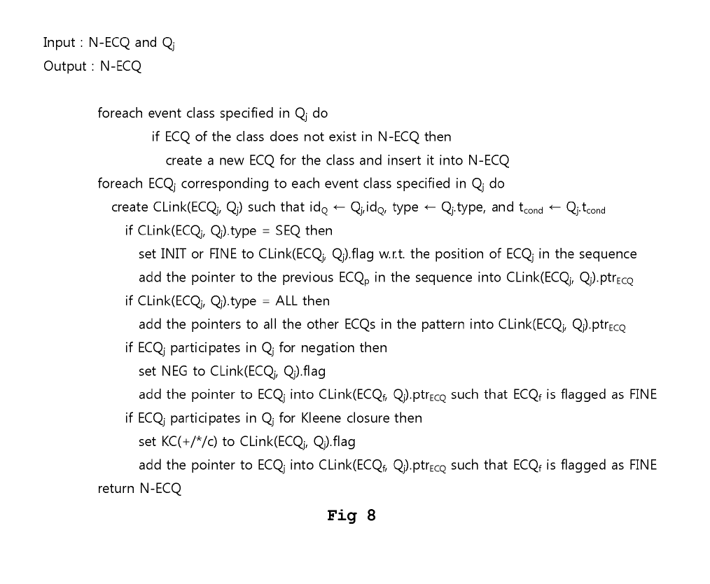

This registration step is performed according to the procedure shown in FIG. 8. First, a process of newly registering one detection sentence Q in an N-ECQ will be described. If a corresponding ECQ does not exist in the N-ECQ, the corresponding ECQ is created, and respective parts of the ECQ are set.

This setting is configured to create CLink for Q and perform basic setting. In the case of an SEQ, INIT and FINE are set for flags and a previous ECQ is linked in conformity with the sequence. In the case of ALL, all participating ECQs are linked, so that the other ECQs will be referred to when event object input occurs later.

If the ECQ is a negation, NEG is set for a flag, an ECQ for which FINE has been set is searched for, and the ECQ is made to point to a corresponding ECQ.

In the case of a Kleene closure, KC (+/*/c: c is an arbitrary natural number) is set for a flag and is linked to an ECQ for which FINE has been set (+: one or more occurrences, *: zero or more occurrences, and c: c or more occurrences).

By this, ECQs representing the results of a complete composite event are enabled to check ECQs participating in a negation and a Kleene closure and determine the completion of the composite event.

A composite event detection sentence deletion step of deleting a composite event detection sentence which is not necessary any longer from the network is performed by deleting CLink corresponding to the detection sentence to be deleted from each ECQ and, if there is no CLink in an ECQ, deleting the ECQ from the N-ECQ because the corresponding ECQ is not necessary any longer.

Meanwhile, an object processing step of, when one event object is input, detecting a composite event in a network of ECQs will be described below.

A process of detecting a composite event starts with searching an N-ECQ for an ECQ corresponding to the event type of an input object and transmitting an event object to the ECQ. A process which is performed within the corresponding ECQ may be divided into two parts.

First, whether the input event object has extended or has newly created a partial combination of each of all detection sentences in which a corresponding ECQ participates is determined. This determination is performed by searching ECQs linked to all registered CLinks of the corresponding ECQ.

This detection is basically performed using the identifier of the agent of the event object, and is performed in a join manner using the hash table of an SIQ. Accordingly, the detection chiefly performed in this part is referred to as probe-join, and this part is referred to as a determination step.

Second, if, as a result of the detection, the input event object has extended or has newly created a partial combination for at least one detection sentence, the corresponding event object is stored in the ECQ once. If the input event object has not influenced any detection sentence, the object is discarded. This part is referred to as a storage step.

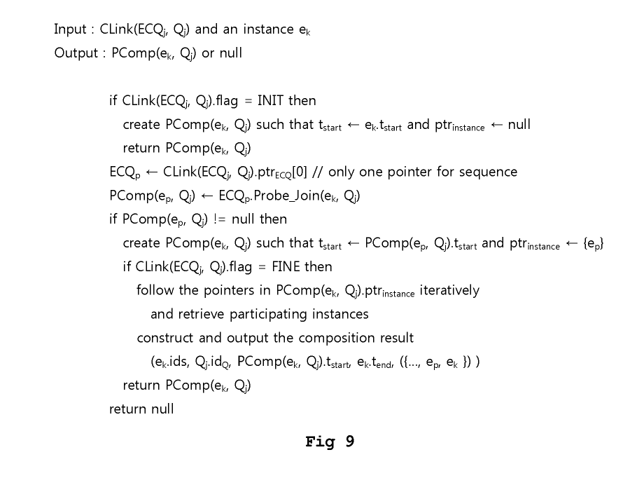

FIG. 9 shows the method of the checking step in a process of detecting a composite event corresponding to a sequence for a specific event object input. If an input event object newly produces a partial combination because a corresponding ECQ corresponds to the foremost part of a detection sentence sequence, the process is terminated. Otherwise, a preceding ECQ present in the sequence is searched for using the pointers of CLink and probe-join detection is performed. If, as a result of the searching, current partial combination is extended by a current input event object, information about the extended partial combination is created. If a currently ECQ corresponds to the rearmost part of a detection sentence sequence, final composite event results are output.

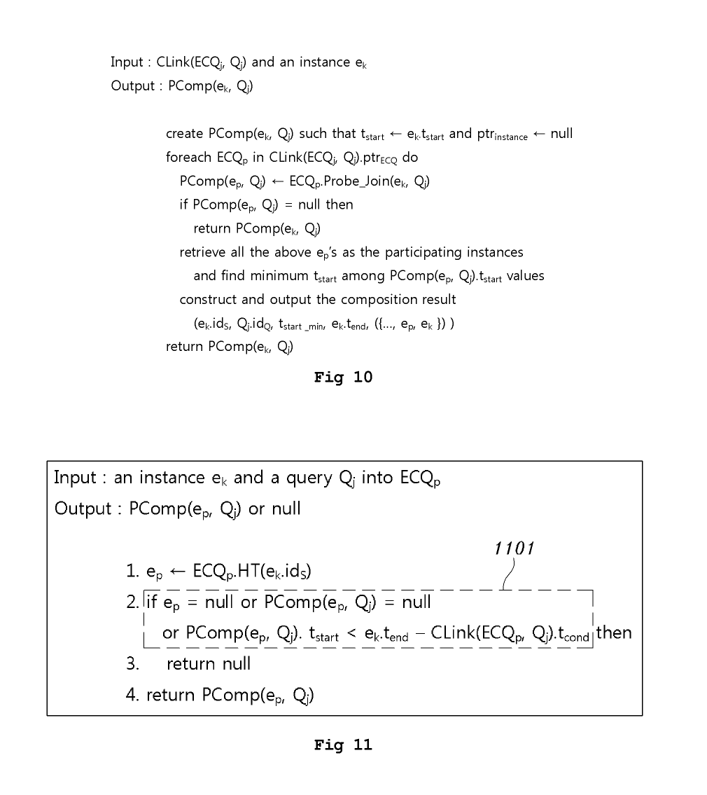

FIG. 10 shows a processing algorithm for the checking step for the case where events occurs in the relationship of a conjunction “AND.” This algorithm is similar to that for the sequence in that probe-join is basically used, but is different in that all input event objects must be stored because they can start partial combination, and final composite event results are not created unless all ECQs linked to CLink are searched for and all pass.

In the case of a disjunction “OR,” composite event results are output even for any input event object, so that the processing thereof is very simple, and therefore a description thereof using code will not be given here.

FIG. 11 shows a probe_join operation used in the algorithms of the above steps.

Whether an input event object having the identifier of a subject identical to that of an input event object has been stored in a corresponding ECQ is determined. If the input event object having the identifier is determined to have been stored, whether partial combination information for the corresponding detection sentence exists is determined. If the partial combination information is determined to exist, the time constraint condition is checked. If the time constraint condition is met, the corresponding partial combination information is transmitted.

The above descriptions of the steps and operations illustrate only the cases where there is neither negation nor Kleene closure. If a negation and a Kleene closure are actually taken into consideration, the probe-join algorithm must first be slightly modified.

In the case of a negation, a condition 1101 must be applied in a contrary manner (that is, examination must be performed in the condition that the if-clause is negated). In the case of a Kleene closure, even the numbers of objects which belong to preceding event objects stored in actual ECQs and satisfy conditions must be compared with each other. Since this part is not very difficult, an illustration thereof is omitted here.

In connection with the modification of the probe-join, the above sequence and conjunction processing method requires slight modification. If the negation and the Kleene closure are taken into consideration for the sequence and the conjunction, ECQs participating in the negation and the Kleene closure are searched for and search results must be considered in the determination of the final composite event, in the process of producing the final results of ECQs which produce results (in the case of sequence, ECQs for which FINE has not been set, and in the case of conjunction, all ECQs). Since this part is also not very difficult, an illustration thereof is omitted here.

The above-described ECQ and the composite event detection method using the ECQ may be applied to actual life, such as the advertising, financial industry, large discount store, logistics, civil engineering and traffic fields.

An application in the advertising field may be configured to provide a function in which a credit card company considers the use of a card by each card user to be a composite event and provides a service of transmitting an advertisement or a coupon based on the real-time usage pattern of the card.

That is, the use of a corresponding card in a specific period (for example, from Saturday afternoon to evening) and at a specific location (a luxury restaurant, a movie theater, or a cafe) may be defined as a composite event, and an advertisement for a specific location (a wine bar having a good atmosphere which is located near the site where the card has been used) is provided to the customer of the corresponding card through a mobile device when such an event is detected.

Furthermore, it is possible to consider a purchase history a composite event using a shopping mall membership card and to provide an advertising service using a path during shopping. In more detail, the purchase of a specific product (a famous brand of a product) may be defined as a composite event and an advertisement for another competitive product or a discount coupon may be transmitted when such an event is detected.

An application in the financial field may be a trading system for defining various symptoms indicative of economic indices as composite events and then analyzing these. An example of this application may be configured to start the program sale of selling stocks when a gross inflow of fund capital is reduced by X % (X is a preset value) (event 1), a gross inflow of foreign investment capital is reduced by Y % (Y is a preset value) (event 2) and the number of stock items which belong to the top 100 stock items and which have decreased stock indices is equal to or larger than Z (Z is a preset value) (event 3), that is, when events 1, 2 and 3 are all met.

An application in a large discount store may be configured to apply to a product display, transfer and theft prevention system based on Radio Frequency Identification (RFID). An example of this application may be configured to define a case where a product A placed on a display shelf is moved from a store without passing through a counter as a composite event and to consider the occurrence of such an event to be a “theft.” Another example of this application may be configured to check the expiration dates of displayed products while passing through a counter using RFID, to define a case where an expiration date has passed to be a composite event, and to deal with a product which may have degraded quality when such an event is detected.

An application in the logistic field may be configured to apply to a logistic monitoring system based on RFID. An example of this application may be configured to construct a system for defining the normal destination of each product and the points of the closest path to the normal destination as composite events and monitoring cases where the product reaches the wrong destination or departs from the normal path.

An application in the civil engineering field may be configured to apply to a facility monitoring system based on the patterns of the movement of citizens. An example of this application may be configured to define a case where citizens use urban facilities as a composite event and to analyze the correlation between the patterns of such events and the facilities by analyzing the patterns.

Furthermore, an application in the traffic field may be configured to apply to a real-time traffic management system based on the analysis of movement patterns using traffic cards. An example of this application may be configured to construct a real-time public transportation management system for defining a transfer to another traffic means using a traffic card to be a composite event, analyzing a movement pattern during a long period such as a day, and adjusting the allocation of vehicles based on the analysis.

Experiments for comparing the performance of the composite event detection method using an ECQ according to the present invention with the performance of the FSA-based composite event detection system for a large amount of event input, which has been researched, will be described below.

In order to check the improvement of performance achieved by the present invention, experiments were carried out in a 64-bit Linux computer. 1000 agents which could create event objects were created, and 1000 event objects were created for each of the agents. In order to compare computational loads with each other, the times taken to process a million event objects were measured. In order to compare the amounts of usage of a storage device with each other, the number of event objects stored in a data structure to process a million event objects was counted. The control group of the present invention was implemented based on automata in accordance with the paper [SASE].

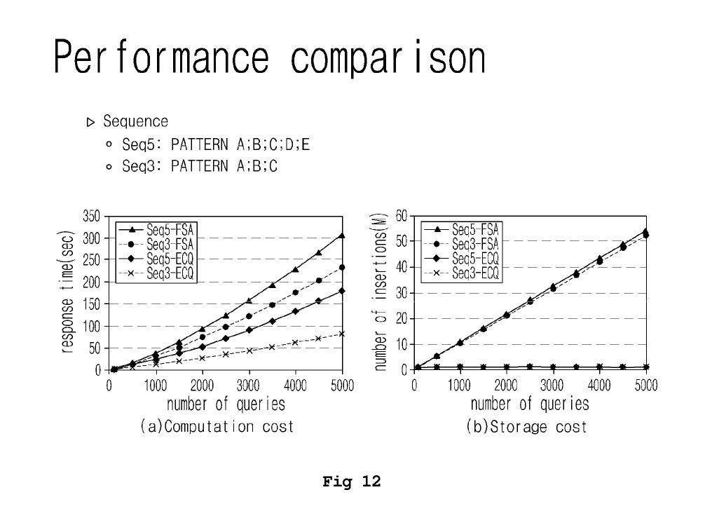

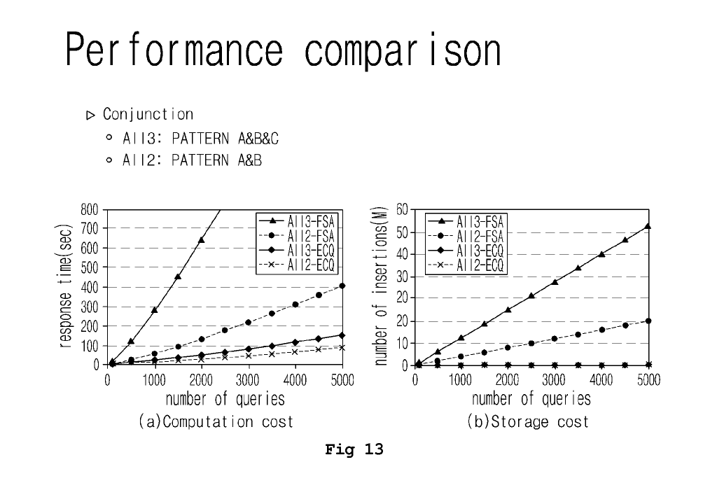

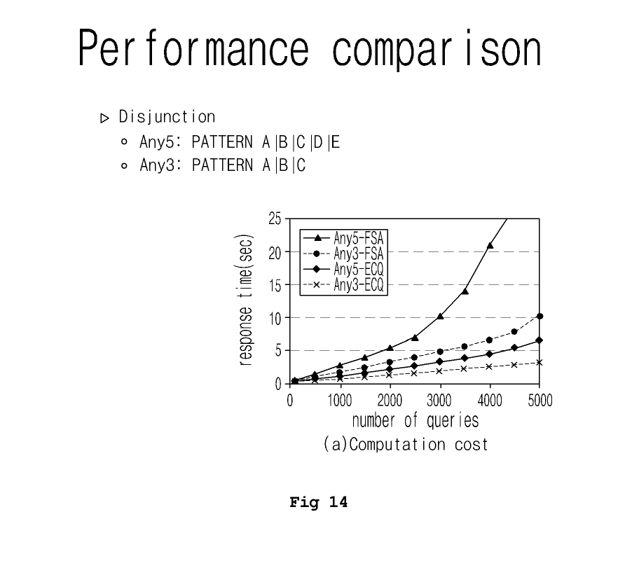

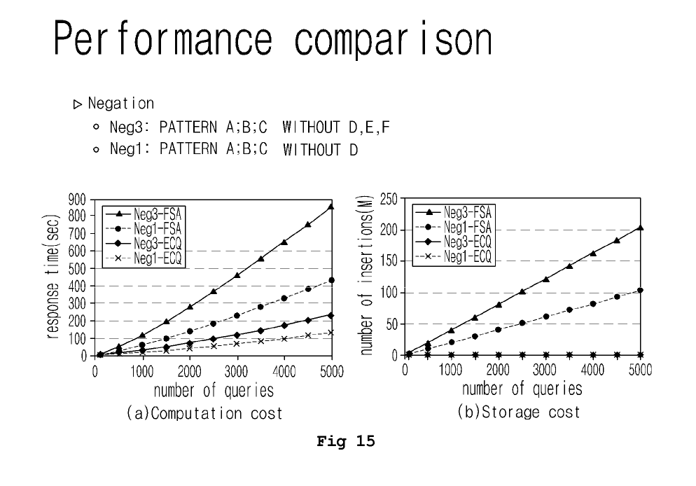

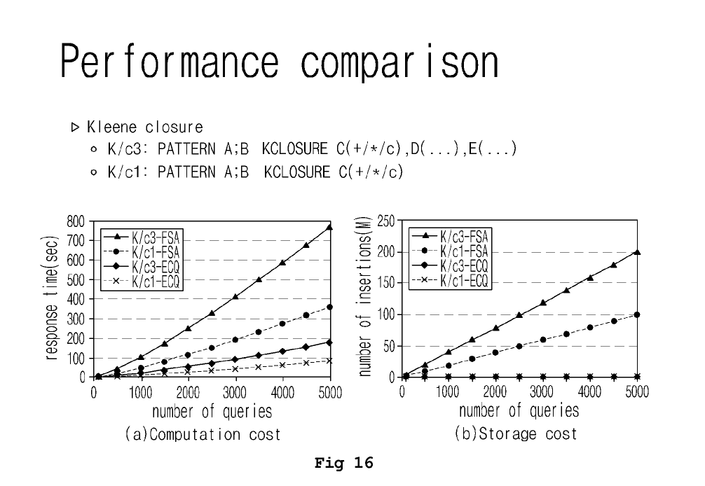

FIG. 12 shows the comparison of performance between the existing FSA-based composite event detection system and the present invention with respect to the Kleene closure. FIG. 13 shows the comparison of performance between the existing FSA-based composite event detection system and the present invention with respect to the sequence. FIG. 14 shows the comparison of performance between the existing FSA-based composite event detection system and the present invention with respect to the conjunction. FIG. 15 shows the comparison of performance between the existing FSA-based composite event detection system and the present invention with respect to the disjunction. FIG. 16 shows the comparison of performance between the existing FSA-based composite event detection system and the present invention with respect to the negation.

In the case of the disjunction of FIG. 15, in order to provide the efficiency of storage space, event objects were not stored in actual implementation. Accordingly, the results of experiments for comparing the amounts of usage of storage space with each other are not illustrated.

From the above experiments, it can be seen that as the number of registered composite event detection sentences increased, the ECQ and the composite event detection method proposed by the present invention exhibited the remarkable improvement of performance compared to the control group.

According to the ECQ and composite event detection method using the ECQ of the present invention, in composite event detection, composite event detection for a plurality of detection sentences appears at one time and, if necessary, a corresponding object is stored inside the ECQ once, thereby providing optimization in terms of the computation and storage costs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An Event-centric Composible Queue (ECQ), comprising:
a Composition Link Table (CLT) having basic information about composition of a network of ECQs;
a Shared Instance Queue (SIQ) for storing preceding event objects which are shared by a plurality of detection sentences and which are required for composite event detection; and
a Partial Composition Block (PCB) for storing intermediate results of calculation of the extent to which each stored event object satisfies a specific composite event detection sentence.

2. The ECQ as set forth in claim 1, wherein the CLT has a row for a composite event detection sentence Qⱼ in which a corresponding ECQ (ECQᵢ) participates, which is denoted by CLink(ECQᵢ, Qⱼ).

3. The ECQ as set forth in claim 2, wherein the CLink(ECQᵢ, Qⱼ) comprises an identifier id_{Q} of a detection sentence, a type of corresponding composite event, Furthermore, a time constraint t_{cond} for completion of a corresponding composite event, a set of pointers ptr_{ECQ} for remaining ECQs, a location or feature flag which a corresponding ECQ has in a corresponding composite event type, and conditions attr_condition of attributes expressed in the composite event detection sentence, as columns thereof.

4. The ECQ as set forth in claim 3, wherein the type has any one value of SEQ for a sequence type, ALL for a conjunction type and ANY for a disjunction type.

5. The ECQ as set forth in claim 3, wherein the flag has any one value of INIT for a foremost part of a sequence, FINE for a rearmost part of a sequence, NEG for a negation type, KC for a Kleene closure type and +(one or more occurrences), (zero or more occurrence), and c (arbitrary natural number; c or more occurrences) which is numerical information of a Kleene closure.

6. The ECQ as set forth in claim 1, wherein the SIQ comprises a queue for storing event objects in order of input and a hash table for efficiently searching for stored event objects.

7. The ECQ as set forth in claim 1, wherein the PCB is created for each stored event object, and has a row denoted by PComp(eₖ, Qⱼ) representative of information about how an event object eₖ stored for each composite event detection sentence partially satisfied by the event object satisfies a detection sentence Qⱼ.

8. The ECQ as set forth in claim 7, wherein the PCB comprises an identifier id_{Q} of a partially satisfied detection sentence, a time tₛₜₐᵣₜ when currently stored partial combination started, and a set of pointers ptr_{instance} of preceding event objects which have enabled partial combination resulting from a currently stored event object eₖ.

9. A composite event detection method using an ECQ, comprising:
implementing and registering a target composite event detection sentence using a network of ECQs;
deleting an unnecessary composite event detection sentence from the network; and
when an event object is input, detecting a composite event from the network of ECQs.

10. The composite event detection method as set forth in claim 9, wherein the detecting a composite event comprises:
checking whether the input event object extends or newly creates partial combination of a corresponding detection sentence for all detection sentences in which a corresponding event participates; and
if the input event object extends or newly creates partial combination of one or more detection sentences, storing the input event object inside the ECQ once, and if the input event object does not extend or newly create partial combination, discarding the input event object.

11. An advertising method using an ECQ, comprising:
implementing and registering a composite event detection sentence, used to compositely detect use of a specific card at a specific location and in a specific period in order to monitor a series of card uses in real time, using a network of ECQs;
deleting an event detection sentence related to use of the specific card at an unnecessary location or in an unnecessary period from the network; and
transmitting a preset advertisement to a relevant mobile device in response to use of the card detected using the composite event detection sentence.

12. An advertising method using an ECQ, comprising:
implementing and registering a composite event detection sentence, used to compositely detect a purchase of a specific product in order to detect a composite shopping activity in real time, using a network of ECQs;
deleting an event detection sentence related to an unnecessary purchase from the network; and
transmitting a preset advertisement or discount coupon in response to a purchase detected using the composite event detection sentence.

13. A finance management method using an ECQ, comprising:
implementing and registering a composite event detection sentence, used to compositely detect a specific economic index in order to understand an economic situation in real time, using a network of ECQs;
deleting an event detection sentence related to an unnecessary index from the network; and
taking preset measures in response to the economic index detected using the composite event detection sentence.

14. A large-sized store product management method using an ECQ, comprising:
implementing and registering a composite event detection sentence, used to compositely detect movement of one of various products in a large-sized store, using a network of ECQs;
deleting an event detection sentence related to an unnecessary product from the network; and
taking preset measures in response to movement of a product detected using the composite event detection sentence.

15. The large-sized store product management method as set forth in claim 14, wherein:
the implementing and registering a composite event detection sentence is implementing and registering a composite event detection sentence used to compositely detect a case where a product is moved from a store without passing through a counter, using a network of ECQs; and
the taking preset measures is providing notification of a theft of the product.

16. The large-sized store product management method as set forth in claim 14, wherein:
the implementing and registering a composite event detection sentence is implementing and registering a composite event detection sentence used to compositely detect a case where a product is moved from a store through a counter and an expiration date of the product has passed, using a network of ECQs; and
the taking preset measures is immediately notifying a customer of the passing of the expiration date.

17. A delivery management method using an ECQ, comprising:
implementing and registering a composite event detection sentence, used to compositely detect arrival of a specific product at a delivery destination and passing of the product through an intermediate location, using a network of ECQs;
deleting an event detection sentence related to an unnecessary product from the network; and
monitoring movement of a product other than movement of the first product detected using the composite event detection sentence.

18. A facilities monitoring method using an ECQ, comprising:
implementing and registering a composite event detection sentence, used to compositely detect use of each of various facilities, using a network of ECQs;
deleting an event detection sentence related to an unnecessary facility from the network; and
analyzing a pattern of the use of facilities detected by the composite event detection sentence.

19. A public transportation management method using an ECQ, comprising:
implementing and registering a composite event detection sentence, used to compositely detect transfer to another transportation means using a traffic card, using a network of ECQs;
deleting an event detection sentence related to unnecessary transfer information from the network; and
managing public transportation based on transfer information detected using the composite event detection sentence.
